(19) United States
(12) Patent Application Publication
(10) Pub. No.: US 2008/0040108 A1
(43) Pub. Date: Feb. 14, 2008

(54) SPEECH PROCESSING APPARATUS AND CONTROL METHOD THEREOF

(75) Inventors: Kenichiro Nakagawa, Tokyo (JP); Toshiaki Fukada, Yokohama-shi (JP); Tsuyoshi Yagisawa, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/834,369

(22) Filed: Aug. 6, 2007

(30) Foreign Application Priority Data
Aug. 11, 2006 (JP) 2006-220641

(51) Int. Cl. G10L 15/00

(52) U.S. Cl. 704/231; 704/E15.001

(57) ABSTRACT

In order to implement proper sensitivity setting with respect to a connected speech input device, this invention includes a connector for detachable connection of a speech input device, a detection unit which detects that the speech input device has connected to the connector, and a setting unit which sets a set value for adjusting a parameter of a speech signal input from the speech input device through the connector in accordance with detection of connection of the speech input device by the detection unit.

### BACKGROUND OF THE INVENTION

1. Field of the Invention

The present invention relates to a speech processing apparatus that processes speech information and a control method thereof.

2. Description of the Related Art

Recently, a speech recognition technique of controlling a device via speech has been put into practice. The speech recognition technique has a great advantage of allowing users such as children, elderly people, and physically handicapped people to control devices through utterances of speech. Such a speech recognition technique has been commercialized in the fields of car navigation systems, telephone services, welfare equipment, and the like.

In general, when a device is to be controlled by speech recognition, speech from the user is captured through a microphone built in the device. Some users may use their own microphones. When using speech recognition in operator work such as telephone operation, the operator often uses his/her own headset microphone, for hygienic reasons. In addition, a physically handicapped user uses a microphone conforming to his/her own physical handicap.

When a user uses speech recognition through his/her own microphone, a device that supports speech recognition needs to have a terminal in which the user's microphone can be inserted. Some apparatuses with speech recognition support have such microphone terminals.

When each user is to use his/her own microphone, a speech recognition system needs to correct for sensitivity, which differs for each microphone. Consider a case wherein a user has selected a microphone with low sensitivity and connected it to a speech recognition system. In this case, it is necessary to change an analog volume or digital volume inside the speech recognition system, thus increasing the amplitude input from the microphone. In contrast, if the user selects a microphone with high sensitivity, it is necessary to change the volume to reduce the amplitude of input speech. Without these adjustments, the speech signal is too small in magnitude, resulting in decrease in signal-to-noise ratio (S/N), or is too large in magnitude, resulting in clipping. Either phenomenon may degrade speech recognition performance.

When changing the microphone to be connected to the speech processing apparatus, the user may forget to perform sensitivity adjustment. Under such a circumstance, Japanese Patent Laid-Open No. 2000-137498 (reference 1) discloses a technique of setting a specific sensitivity value, which has been set in advance, at a specific timing. More specifically, the disclosed technique is a technique of automatically adjusting the optimal sensitivity in the recording mode upon switching to a specific sensitivity set in advance, in response to switching of recording modes by a user as a trigger, instead of manually performing sensitivity adjustment.

The technique disclosed in reference 1 is an effective technique for a case wherein an optimal sensitivity can be determined in advance. However, if it is unknown what kind of microphone the user will use, it is impossible to determine a set value that achieves optimal sensitivity in advance. The speech recognition performance may be degraded as a result.

### SUMMARY OF THE INVENTION

The present invention has been made in consideration of the above problems, and has as its object to provide a technique of allowing a more appropriate sensitivity to be set, even in a case wherein it is not known in advance which speech input device will be connected to the speech processing apparatus.

According to one aspect of the present invention, a speech processing apparatus comprising: a connector for detachable connection of a speech input device; a detection unit which detects that the speech input device has connected to the connector; and a setting unit which sets a set value for adjusting a parameter of a speech signal input from the speech input device through the connector in accordance with detection of connection of the speech input device by the detection unit.

According to another aspect of the present invention, a speech processing method executed by a speech processing apparatus comprising a connector for detachable connection of a speech input device, the method comprising the steps of: detecting that the speech input device has connected to the connector; and setting a set value for adjusting a parameter of a speech signal input from the speech input device through the connector in accordance with detection of connection of the speech input device in the detection step.

A technique may be provided that implements a more suitable sensitivity setting with respect to a speech input apparatus connected to a speech processing apparatus.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the functional arrangement of a speech processing apparatus according to the first embodiment;

FIG. 2 is a view showing an example of a dialog screen as a GUI screen for sensitivity adjustment;

FIG. 3 is a flowchart showing the operation of a speech processing apparatus according to the first embodiment;

FIG. 4 is a block diagram showing the functional arrangement of a speech processing apparatus according to a modification;

FIG. 5 is a view showing an example of a sensitivity table;

FIG. 6 is a block diagram showing the functional arrangement of a speech recognition apparatus as a speech processing apparatus according to the second embodiment;

FIG. 7 is a view showing an example of a dialog screen as a GUI screen for speech recognition parameter adjustment;

FIG. 8 is a view exemplarily showing the operation panel of a copying machine according to the third embodiment; and

FIG. 9 is a view exemplarily showing a setting screen displayed on the operation panel.

### DESCRIPTION OF THE EMBODIMENTS

The preferred embodiments of the present invention will be described in detail below with reference to the accompanying drawings. Note that these embodiments are merely examples, and the scope of the present invention is not limited thereto.

### First Embodiment

### <Outline>

In the first embodiment, a setting screen for sensitivity adjustment for a speech input device is displayed on the display unit of a speech processing apparatus in response to the connection of the speech input device to the speech processing apparatus as a trigger. This arrangement allows the user to execute sensitivity adjustment for the speech input device without fail.

<Apparatus Arrangement>

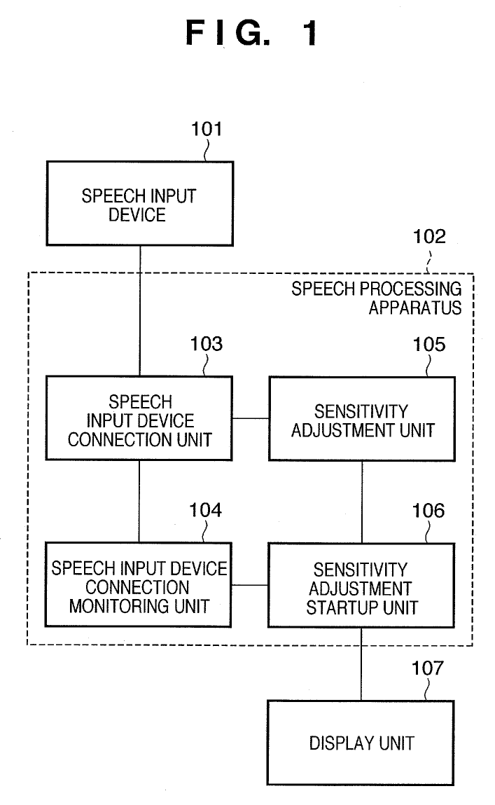

FIG. 1 is a block diagram showing the functional arrangement of the speech processing apparatus according to the first embodiment.

A speech input device 101 such as a microphone connects to a speech processing apparatus 102 of the present invention through a speech input device connection unit 103. The speech processing apparatus 102 is an apparatus which processes speech signals input through the speech input device 101. Note that in this case, a typical 3.5 mm stereo mini-plug connector as a microphone terminal is assumed, as the speech input device connection unit 103.

A speech input device connection monitoring unit 104 monitors the speech input device connection unit 103 to detect its connection status with respect to the speech input device 101. Upon detecting connection, i.e., a change from a non-connection status to a connection status, the speech input device connection monitoring unit 104 notifies a sensitivity adjustment startup unit 106 of corresponding information as an event. This event may be notified by implementing a hardware/software interrupt or setting a specific value in a memory area (not shown) which the speech processing apparatus 102 has.

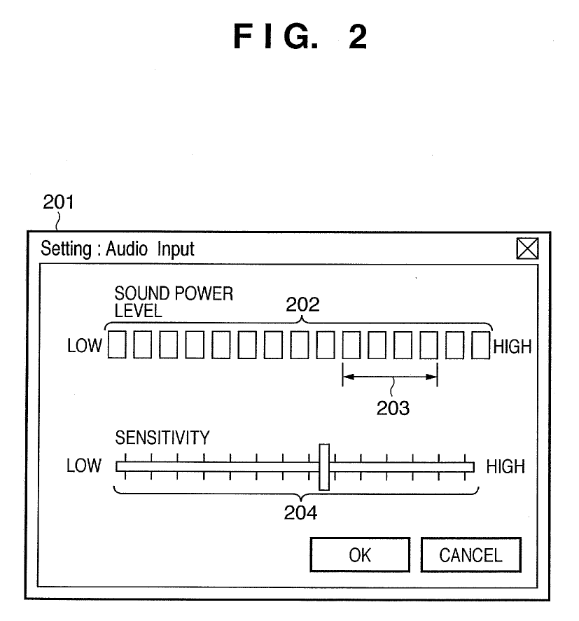

Upon receiving the notification of the connection of the speech input device 101 from the speech input device connection monitoring unit 104, the sensitivity adjustment startup unit 106 starts up a sensitivity adjustment unit 105, and displays a dialog screen for setting operation to be described later on a display unit 107. The sensitivity adjustment unit will be described below with reference to FIG. 2.

In the following description, the speech input device 101 is presumed to be a microphone, the speech processing apparatus 102 is presumed to be a sound board.

<Sensitivity Adjustment GUI Screen>

A technique of increasing or reducing the input amplitude of speech input from the speech input device 101 will be referred to as a sensitivity adjustment technique. For example, in a general recording apparatus, the user can set a set value for sensitivity adjustment by manually operating a physical dial or slide bar. A device which can present a graphical user interface (GUI) like a personal computer (PC) displays a GUI setting screen on the display unit. In this case, a set value for sensitivity adjustment can be set by accepting the operation of the keyboard or mouse by the user.

FIG. 2 is view showing an example of a dialog screen as a GUI screen for sensitivity adjustment.

A sound power indicator 202 and a sensitivity slider 204 are arranged on a dialog screen 201. The sound power indicator 202 displays the sound power of speech input from the speech input device 101 in real time. The sensitivity slider 204 receives the sensitivity adjustment amount designated by the user by, for example, mouse dragging operation. In this case, as the user moves the slider to the right, the sensitivity increases.

More specifically, the user utters to the microphone as the speech input device 101, and sees the display state of the sound power indicator 202. The user then adjusts the sensitivity by moving the sensitivity slider 204 to the left and right such that the level indication at the time of utterance falls within a proper range index 203. It also suffices to configure the apparatus to perform automatic adjustment on the basis of user's utterance.

<Operation of Apparatus>

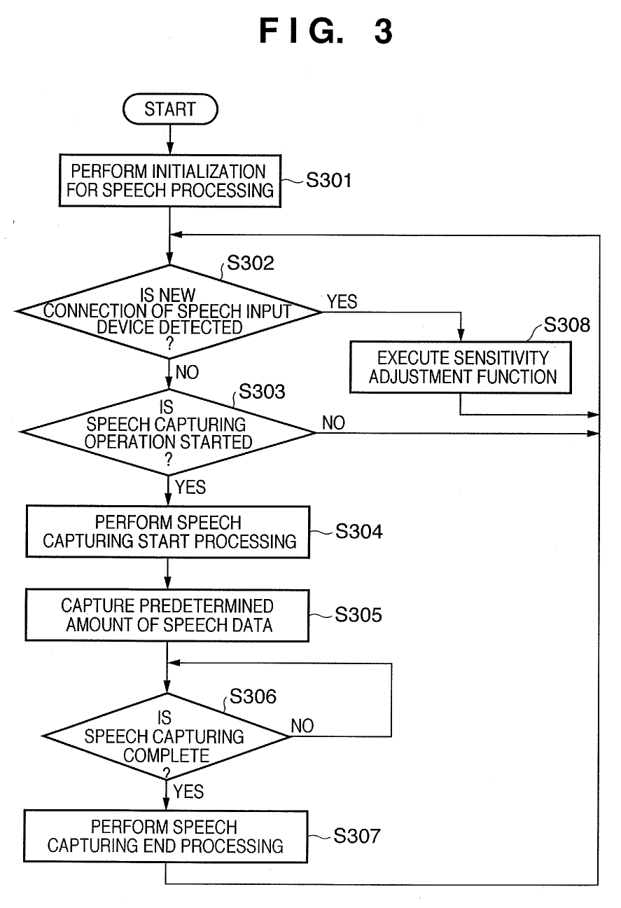

FIG. 3 is a flowchart showing the operation of the speech processing apparatus according to the first embodiment. When the user turns on the power supply of the speech processing apparatus, the apparatus executes the following procedure.

In step S301, the apparatus performs initialization for speech processing. This processing corresponds to initialization for the sound board. That is, the apparatus performs operation for preparation for speech processing, e.g., initializing various kinds of parameters used for speech processing and loading internal data.

In step S302, the speech input device connection monitoring unit 104 checks whether the speech input device 101 such as a microphone has connected to the speech input device connection unit 103. If YES in step S302, that is, the speech input device connection monitoring unit 104 determines that a non-connection status has changed to a connection status, the speech input device connection monitoring unit 104 notifies the sensitivity adjustment startup unit 106 of the event. The process advances to step S308. If the speech input device connection monitoring unit 104 detects no change, the process advances to step S303.

In step S308, the sensitivity adjustment startup unit 106 starts up the sensitivity adjustment unit 105 on the basis of the event notified from the sensitivity adjustment startup unit 106. The sensitivity adjustment unit 105 then prompts the user to perform the sensitivity adjustment described with reference to FIG. 2 and set set values for sensitivity adjustment. More specifically, the sensitivity adjustment unit 105 displays the dialog screen 201 on the display unit 107. When the sensitivity adjustment is terminated as, for example, the user presses the “OK” button on the dialog screen 201, the process returns to step S302.

In step S303, the apparatus checks whether to start speech capturing operation. This processing changes depending on the system incorporated in this speech processing apparatus. If, for example, this apparatus is incorporated in the speech recognition system, pressing the “speech recognition start” button is equivalent to issuing an instruction to start this processing. If this apparatus determines that it suffices not to start speech capturing operation, the process returns to step S302.

In step S304, the apparatus performs speech capturing start processing. This processing is equivalent to issuing an instruction to start speech capturing operation through a device driver corresponding to the sound board.

In step S305, the apparatus acquires a predetermined amount of speech data from the speech input device through the sound board. Processing for the acquired speech data is relegated to the system in which this apparatus in incorporated. If, for example, the apparatus is incorporated in a speech recognition system, a predetermined amount of speech data captured in this case is relegated to speech recognition processing.

In step S306, the apparatus determines whether to terminate speech capturing operation. For example, when the user presses the “speech capture end” button, the apparatus terminates speech capturing operation. Assume that this apparatus in incorporated in a speech recognition system. In this case, the apparatus terminates the speech capturing operation upon acquiring a predetermined amount of speech data necessary for speech recognition.

In step S307, the apparatus performs speech capturing end processing. For example, issuing an instruction to terminate speech capturing operation through a device driver corresponding to the sound board is equivalent to the speech capturing end.

As has been described above, according to the speech processing apparatus of the first embodiment, when a microphone is newly connected to the apparatus, the dialog screen 201 for setting is displayed on the display unit 107 to allow the user to perform sensitivity adjustment without fail. This makes it possible to capture speech with proper sensitivity even if the currently used microphone is switched to another one. In addition, for example, the dialog screen 201 for setting is not displayed if a microphone is always connected, which makes it possible to avoid unnecessarily cumbersome operation. According to the above description, when the speech input device 101 such as a microphone connects to the apparatus, the apparatus always displays the dialog screen 201 for setting. Setting may be made to perform switching operation. For example, it suffices to provide an item like the item “Display setting dialog upon detection of connection of microphone” on a setting screen (not shown) on the device driver. This arrangement can avoid cumbersome operation when it is known that a plurality of users use the same type (model number) of microphone.

(Modification)

In the first embodiment described above, as the speech input device connection unit 103, a typical 3.5 mm stereo mini-plug connector is assumed. However, it is possible to use, for example, a universal serial bus (USB) connector. In this case, it is possible to acquire a “device IDT” indicating the type of the speech input device 101 connected to the apparatus.

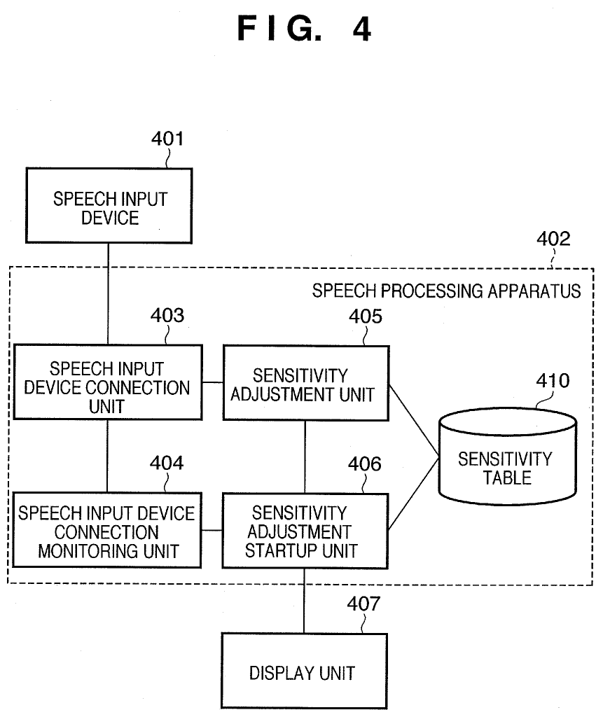

FIG. 4 is a block diagram showing the functional arrangement of the speech processing apparatus according to the modification. This apparatus differs from that shown in FIG. 1 in that it has a sensitivity table 410 storing a sensitivity setting parameter for each device ID.

A speech input device connection monitoring unit 404 monitors a speech input device connection unit 403 to detect its connection status with respect to a speech input device 401. Upon detecting connection, i.e., a change from a non-connection status to a connection status, the speech input device connection monitoring unit 404 acquires the device ID of the speech input device 401. The speech input device connection monitoring unit 404 then notifies a sensitivity adjustment startup unit 406 of the device ID together with the event.

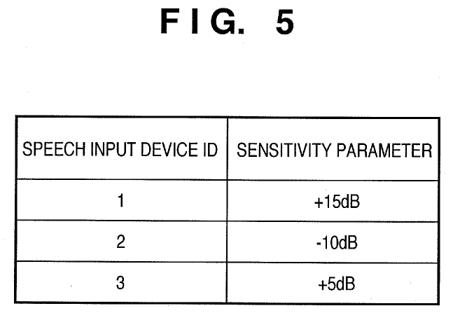

Upon receiving the notification of the connection of the speech input device 401 from the speech input device connection monitoring unit 404, the sensitivity adjustment startup unit 406 refers to the sensitivity table 410. FIG. 5 is a view showing an example of a sensitivity table. The sensitivity table 410 stores device IDs and sensitivity parameters set in advance by the speech input devices 401 corresponding to the device IDs.

If the device ID corresponding to the speech input device 401 currently connected to the apparatus has already been stored in the sensitivity table 410, the sensitivity adjustment startup unit 406 reads the corresponding sensitivity parameter. The sensitivity adjustment startup unit 406 performs sensitivity adjustment on the basis of the read sensitivity parameter but does not start up a sensitivity adjustment unit 405. That is, the dialog screen 201 is not displayed. In contrast to this, if the device ID corresponding to the speech input device 401 currently connected to the apparatus has not been stored in the sensitivity table 410, the sensitivity adjustment startup unit 406 starts up the sensitivity adjustment unit 405. The sensitivity adjustment startup unit 406 adds the set sensitivity parameter to the sensitivity table 410.

If, for example, the speech input device 401 with the device ID “4” newly connects to the apparatus, the sensitivity parameter corresponding to the device ID “4” is not registered in the sensitivity table 410 shown in FIG. 5. Therefore, the apparatus displays the dialog screen 201 and receives a setting from the user. The apparatus then stores the set sensitivity parameter in the sensitivity table 410, together with ID=“4”.

As described above, according to the speech processing apparatus of the present modification, the dialog screen 201 for setting is displayed on the display unit 107 only when the speech input device 401 of a new type (device ID) is connected to the apparatus. For this reason, if a microphone of the same type (device ID) connects to the apparatus, the dialog screen 201 for setting is not displayed avoiding unnecessarily cumbersome operation.

The preceding description has been made on the assumption that the speech input device connection unit 403 is a USB device. However, the apparatus may be configured such that, even when a speech input device is connected to the apparatus through the above stereo mini-plug connector, the apparatus measures an analog characteristic, such as the impedance of the speech input device, and identifies the speech input device on the basis of the measured characteristic.

### Second Embodiment

### <Outline>

The second embodiment will exemplify a case wherein the speech processing apparatus of the present invention is incorporated in an apparatus having a speech recognition function. When each user carries his/her own microphone with him/her, a change of a microphone indicates a change of an utterer (user). Therefore, when a user connects his/her microphone to the apparatus, adapting the speech recognition apparatus to the user can effectively improve the speech recognition performance.

<Apparatus Arrangement>

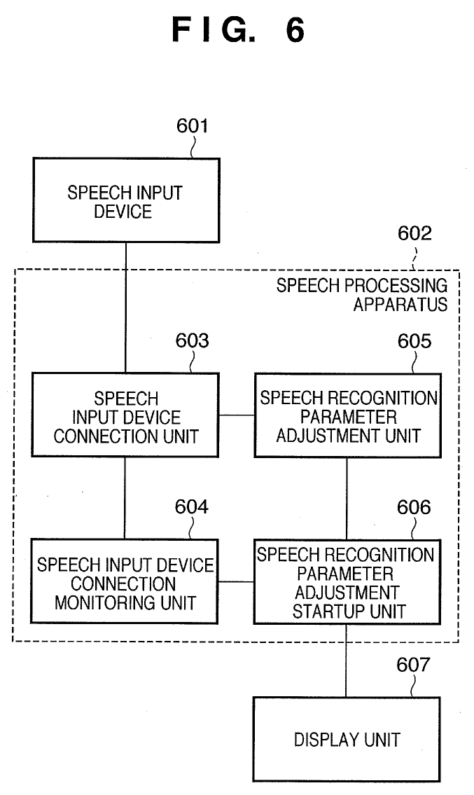

FIG. 6 is a block diagram showing the functional arrangement of a speech recognition apparatus as a speech processing apparatus according to the second embodiment.

A speech input device 601 such as a microphone connects to a speech recognition apparatus 602 of the present invention through a speech input device connection unit 603. The speech recognition apparatus 602 is an apparatus which performs recognition processing for a speech signal input through the speech input device 601. Note that in this case, as the speech input device connection unit 603, a general 3.5 mm stereo mini-plug connector as a microphone terminal is assumed.

A speech input device connection monitoring unit 604 monitors the speech input device connection unit 603 to detect its connection status with respect to the speech input device 601. Upon detecting connection, i.e., a change from a non-connection status to a connections status, the speech input device connection monitoring unit 604 notifies a speech recognition parameter adjustment startup unit 606 of corresponding information as an event. This event may be notified by implementing a hardware/software interrupt or setting a specific value in a memory area (not shown) which the speech processing apparatus 602 has.

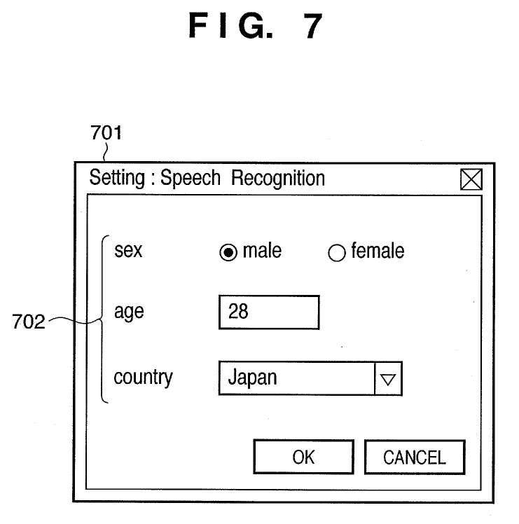

Upon receiving the notification of the connection of the speech input device 601 from the speech input device connection monitoring unit 604, the speech recognition parameter adjustment startup unit 606 starts up a speech recognition parameter adjustment unit 605, and displays a dialog screen for setting operation to be described later on a display unit 607. The speech recognition parameter adjustment unit will be described below with reference to FIG. 7.

FIG. 7 is a view showing an example of a dialog screen as a GUI screen for speech recognition parameter adjustment.

A dialog screen 701 is configured to receive settings of various kinds of speech recognition parameters 702 such as pieces of information associated with the sex, age, and language of an utterer. The speech recognition apparatus 602 executes speech recognition on the basis of the speech recognition parameters set on this screen.

Note that using the speech recognition parameters 702 makes it possible to change calculation processing in speech recognition, data to be used (acoustic model), a speech recognition grammar, and the like to appropriate ones and improve the speech recognition performance. For example, a plurality of acoustic models are prepared in advance for each sex and age group of utterers. This allows to select a proper acoustic model from the sex and age information of the utterer set on the dialog screen 701 described above and use it for speech recognition processing. In addition, acquiring language information can change the speech recognition grammar used for speech recognition processing.

Note that it suffices to configure the apparatus to automatically extract parameters by letting a user utter instead of letting the user set parameters by using the dialog screen 701 as a GUI. For example, it suffices to display only a message for prompting the user to utter on the display unit 607 so as to acquire the sound power of user's utterance as a speech recognition parameter. Alternatively, it suffices to acquire a cepstral mean during utterance as a speech recognition parameter. The apparatus can use the sound power information of the user as a parameter for speech interval extraction processing. In addition, cepstral mean subtraction as a known technique can be used for cepstral mean information during utterance. This can improve the speech recognition performance.

Note that it suffices to configure the apparatus to detect a change of a user by means other than detecting the connection of a microphone. For example, it suffices to execute speaker identification (speaker class identification) as a known technique and start up an adjustment application when a user different from the user at the time of previous sensitivity adjustment (or previous speech recognition parameter adjustment) is using the apparatus. Some device requires the user to log in when he/she is to use the device. Such a device may detect a change of a user in accordance with log-in ID information. For example, when a user who has logged in with the ID “A” performs adjustment first, and then a user logs in with the ID “B”, it suffices to regard this case as a change of a user. In addition, the apparatus may be configured to display the above dialog screen when the sound power captured by the speech input device falls outside a proper value in addition to a change of a user. When, for example, the apparatus performs speech identification to determine that the current user is different from the user who made the previous adjustment, and the sound power of currently input speech falls outside a proper value, the apparatus starts up the sensitivity adjustment application. This makes it possible to execute various types of adjustment only when a user who greatly differs in the volume of speech from the user who has made the previous sensitivity adjustment uses the apparatus.

As described above, according to the speech recognition apparatus of the second embodiment, when the user newly connects a microphone to the apparatus, the dialog screen 701 for setting is displayed on the display unit 607. This makes is possible for the user to perform speech recognition parameter adjustment without fail. This allows the apparatus to perform speech recognition processing with proper speech recognition parameters and obtain a higher recognition ratio.

### Third Embodiment

### <Outline>

The third embodiment will exemplify a case wherein the speech processing apparatus of the present invention is incorporated in a copying machine comprising a speech recognition apparatus and a speech synthesis apparatus. Recently, a copying machine has been commercialized, which can be operated by only speech dialog using speech recognition and speech synthesis, which are known techniques. These products are characterized in that they allow visually or upper limb handicapped users to easily operate.

<Apparatus Arrangement>

Only the arrangement of the operation unit of the copying machine will be briefly described below.

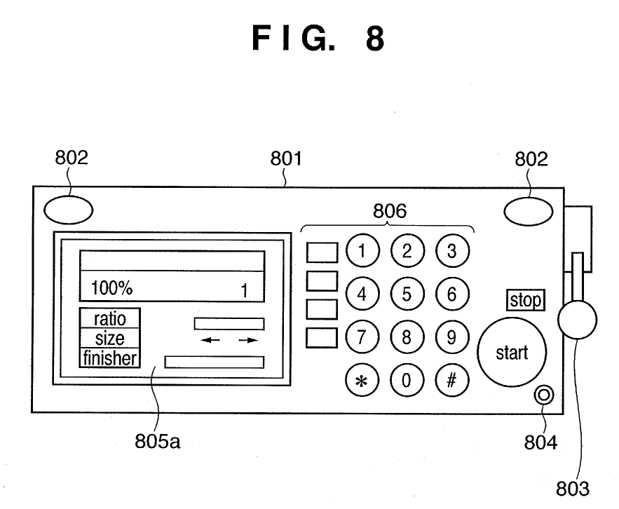

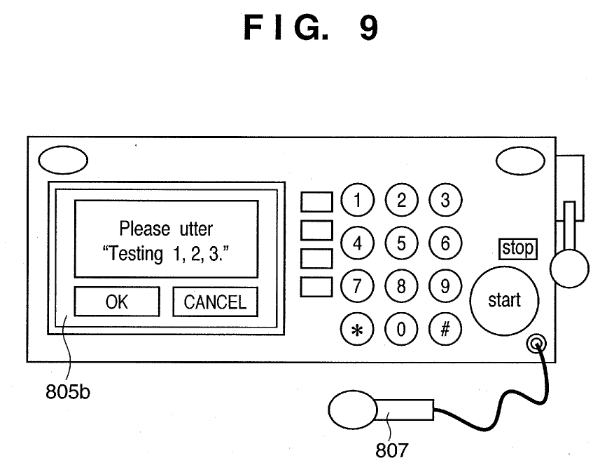

FIGS. 8 and 9 exemplarily show the operation panel of the copying machine according to the third embodiment.

An operation panel 801 comprises a touch screen 805 which can display a GUI and buttons 806 including a ten-key pad and the like. For example, the user can make various settings for the copying function (e.g., the number of copies, a paper size, and a density setting) by performing operation through a copy setting screen 805a displayed on the touch screen 805.

This copying machine further comprises a speaker 802 for outputting the speech generated by speech synthesis and a built-in microphone 803 for inputting a speech command. The user can operate the copying machine by speech dialog using these components. The copying machine further comprises an external microphone terminal 804 for a user who wants to use a microphone other than the built-in microphone. Connecting the microphone which the user wants to use (which will be referred to as an external microphone 807 hereinafter) to this terminal allows the user to use the external microphone instead of the built-in microphone. When the user connects the external microphone 807 to the external microphone terminal, the copying machine displays a sensitivity adjustment screen 805b on the touch screen 805.

For example, referring to FIG. 9, the copying machine displays “Please utter, Testing 1, 2, 3.” on the GUI screen on the touch screen to prompt the user to utter “Testing 1, 2, 3”. Alternatively, for a visually handicapped user, the copying machine may output the synthesized speech “Please utter, Testing 1, 2, 3” from the speaker.

The copying machine captures the speech “Testing 1, 2, 3” uttered by the user and calculates proper sensitivity from the speech. For example, using a known technique typified by auto gain control (AGC) makes it possible to semi-automate calculation and setting of proper sensitivity.

The copying machine often produces noise at the time of specific operation. For example, during copying operation using an auto document feeder (ADF), the copying machine produces very large noise. If the user performs sensitivity adjustment for the microphone under such noise, the microphone captures noise. As a result, improper sensitivity may be set by AGC. In order to avoid such a situation, it is preferable for the copying machine to avoid starting up the sensitivity adjustment application until the end of specific operation (e.g., copying operation using the ADF), if the copying machine is performing the operation, even if the connection of a microphone is detected. In this case, upon detecting the connection of a microphone, the copying machine may notify the user of the corresponding information by displaying, for example, the dialog “sensitivity adjustment will be performed after operation” on the screen.

As described above, according to the copying machine of the third embodiment, when the user connects an external microphone to the machine, the machine displays the sensitivity adjustment screen 805b on the touch screen 805 to allow the user to perform sensitivity adjustment without fail. This makes it possible to capture speech with proper sensitivity even if the user connects an external microphone in place of the currently attached microphone.

### Other Embodiments

Note that the present invention is also implemented by directly or remotely supplying programs for implementing the functions of the embodiments described above to a system or apparatus and causing the system or apparatus to read out and execute the supplied program codes. The program codes themselves therefore which are installed in the computer to allow the computer to implement the functions/processing of the present invention are also included in the technical range of the present invention.

In this case, each program may take any form, e.g., an object code, a program executed by an interpreter, and script data supplied to an OS, as long as it has the function of the program.

As a recording medium for supplying the programs, a floppy (registered trademark) disk, hard disk, optical disk (CD or DVD), magnetooptical disk MO, magnetic tape, nonvolatile memory card, ROM, or the like is available.

In addition, the functions of the above embodiments are implemented by executing readout programs. The functions of the above embodiments can also be implemented by causing an OS or the like running on the computer to perform part or all of actual processing on the basis of the instructions of the programs.

The programs read out from the recording medium are written in the memory of a function expansion board inserted into the computer or a function expansion unit connected to the computer. The CPU of the function expansion board or function expansion unit performs part or all of actual processing on the basis of the instructions of the programs. This processing also implements the functions of the embodiments described above.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-220641, filed Aug. 11, 2006, which is hereby incorporated by reference herein in its entirety.

What is claimed is:

1. A speech processing apparatus comprising:;
a connector for detachable connection of a speech input device;
a detection unit which detects that the speech input device has connected to said connector; and
a setting unit which sets a set value for adjusting a parameter of a speech signal input from the speech input device through said connector in accordance with detection of connection of the speech input device by said detection unit.

2. The apparatus according to claim 1, wherein the parameter is a signal level of a speech signal.

3. The apparatus according to claim 1, wherein said setting unit sets the set value on the basis of speech input to the speech input device.

4. The apparatus according to claim 1, wherein said setting unit presents a GUI for setting the set value to a user in accordance with detection of connection of the speech input device by said detection unit, and sets a set value input by the user through the GUI.

5. The apparatus according to claim 1, further comprising an identifying unit which identifies a type of speech input device connected to said connector,
wherein said setting unit acquires a parameter corresponding to the type of speech input device identified by said identifying unit in accordance with detection of the speech input device by said detection unit by referring to a storage unit storing types of speech input devices and parameters associated with speech inputs in association with each other, and sets the acquired parameter.

6. The apparatus according to claim 5, wherein when said storage unit does not store a parameter corresponding to the type of speech input device identified by said identifying unit, said setting unit presents a screen for setting the parameter.

7. A speech processing method executed by a speech processing apparatus comprising a connector for detachable connection of a speech input device, the method comprising the steps of:
detecting that the speech input device has connected to the connector; and
setting a set value for adjusting a parameter of a speech signal input from the speech input device through the connector in accordance with detection of connection of the speech input device in the detection step.

8. A program stored in a computer-readable storage medium to cause a computer to execute a speech processing method defined in claim 7.
